(19) United States
(12) Patent Application Publication
(10) Pub. No.: US 2026/0078243 A1
(43) Pub. Date: Mar. 19, 2026

(54) SYNTHETIC WOOD PRODUCT

(71) Applicant: SYMMETRY WOOD LLC, Chicago, IL (US)

(72) Inventors: Gabriel Enrique Badia TAVAS, Chicago, IL (US); Timothy D. KEATING, Chicago, IL (US)

(21) Appl. No.: 19/397,785

(22) Filed: Nov. 21, 2025

Related U.S. Application Data
(63) Continuation of application No. 18/115,606, filed on Feb. 28, 2023.
(60) Provisional application No. 63/314,859, filed on Feb. 28, 2022.

(51) Int. Cl. C08L 1/02; B27N 1/02; B27N 3/00; B27N 3/04; B27N 3/08; C08L 5/00; C08L 5/12

(52) U.S. Cl. CPC C08L 1/02; B27N 1/02; B27N 3/002; B27N 3/04; B27N 3/08; C08L 5/00; C08L 5/12

(57) ABSTRACT

A synthetic wood, systems and methods for producing the synthetic wood as an alternative to naturally grown wood, plastic, ceramic, stone, or other materials, including forming and processing bacterial cellulose. The resulting synthetic wood is stable at room temperature and can be made to exhibit mechanical properties, such as hardness, similar to naturally grown wood obtained from high-value trees subject to deforestation.

### CROSS REFERENCE TO RELATED APPLICATION

This application claims the benefit of priority under 35 U.S.C. § 119 (e) to U.S. patent application Ser. No. 18/115,606, filed Feb. 28, 2023, which claims the benefit of priority under 35 U.S.C. § 119 (e) to U.S. Provisional Patent Application No. 63/314,859, filed Feb. 28, 2022, each of which is incorporated herein by reference in its entirety.

The present teachings relate generally to organic synthetic wood products and, in some embodiments, to substitutes for high-value wood (plant cellulose) that are produced using bacterial cellulose. Methods of making the synthetic wood products are also described.

### BACKGROUND

Degradation due to logging for high-value woods, and the subsequent deforestation, continues to destroy highly-biodiverse and critical natural forests and contributes to the death and displacement of indigenous people. In 2021 alone, the Institute for Man and the Environment of the Amazon estimated that the rate of deforestation of the Amazon increased by 33% over the same period in 2020. Many commercial alternatives to wood products further contribute to environmental degradation, including rubber-based products, and petroleum-based plastics. Organic alternatives are often more easily bio-recycled, leading to a search for such stable compounds. Bacterial cellulose alternatives often degrade rapidly when exposed to water, and are thus not suitable for use in environments subject to dampness. Other mixed materials include pykrete, a mixture of sawdust and frozen water. Under the right conditions, pykrete can have an impact resistance reportedly exceeding some forms of concrete and was even explored by the British military for ship construction. However, pykrete is limited by temperature, in that the ice components eventually melt. Accordingly, there is a room in the art for stable cellulose-based alternatives to wood and plastic materials.

### SUMMARY

The scope of the present invention is defined solely by the appended claims and is not affected to any degree by the statements within this summary.

Synthetic wood comprised of bacterial nanocellulose which may include one or more additives is described. These additives can include binding agents, such as gels or other binders; agricultural residues, and bio-based chemical agents.

The synthetic wood may contain residual water. The one or more gels may include those selected from agar, organic gelatins, xanthan gum, alginate, carrageen, hydrocolloids, sodium alginate, propylene glycol alginate, carrageenan, cellulose gum, microcrystalline cellulose (MCC), gellan gum, guar gum, gum Arabic, locust bean gum, sargassum and other seaweed-derived agents, and mixtures thereof. Advantageously, the synthetic wood may be used to form articles of manufacture similar to those formed using naturally grown wood (i.e., from plant cellulose) without the environmental impact caused by tree harvesting. The bacterial nanocellulose is also capable of acting as a binder with cellulosic agricultural residues, such as hemp straw, corn stoves, wheat straw, bagasse, and even things like coffee grounds and/or peanut shells. The bacterial nanocellulose may be comprised of vegetable or bacterial nanocellulose.

The described synthetic wood may also include a binder, an additive, or mixtures thereof. The binder may be any one or more of those selected from guar gum, ammonium lignosulfonate, chitosan, lignin, arrowroot, cassava, tapioca, yucca, manioc, organic starch, potato starch, pectin, [poly (Acrylic acid-co-N-Methylol Acrylamide-co-Butyl Acrylate) Copolymer Grafted Carboxymethyl Cellulose], soy protein, polyacrylic acid, liquid plant hydrolysate, magnesium oxide, xanthan gum, agar, seaweed extract, kelp, sulfite liquor, wheat flour, sucrose, and mixtures thereof. The additive may be any one or more of polyhydroxyalkanoate (PHA), polylactide (PLA), polybutylene adipate terephthalate (PBAT), polybutyl succinate (PBS), cellophane, glycerol monostearate, shellac, wax, natural gum, castor oil, flax oil, linseed oil, menthol crystals, zein, dyes, colorants, glycerin, alcohols, polyols, citric acid, and mixtures thereof.

Methods of making the synthetic wood, which may be free of plant cellulose include providing bacterial cellulose; combining the bacterial cellulose with a gel to form a mixture; at least partially dehydrating the mixture to form a semi-solid mass; compressing the semi-solid mass; and dehydrating the compressed semi-solid mass to remove water present in the compressed semi-solid mass and to form the synthetic wood.

The bacterial cellulose may be provided as a solid product, as a mixture of bacterial cellulose and water (and other components that may be present from the manufacture of the bacterial cellulose), or as a combination of a solid product and a mixture.

In some embodiments, the dehydrating and compressing may be conducted sequentially or, in some instances, may be conducted simultaneously.

Additionally or alternatively, the method may include adding a binder and/or an additive before, during, or after combining the bacterial cellulose with the gel. The binders and additives include those mentioned above.

As used in the description and claims, the term “synthetic wood” refers to a product that can exhibit properties similar to that of natural wood, i.e., wood produced from trees or plant cellulose which may contain plant cellulose.

References to a percentage in the following description and claims refer to a percent by weight unless specifically noted otherwise.

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

### BRIEF DESCRIPTION OF THE DRAWINGS

FIG. 1 depicts one embodiment for producing synthetic wood products as an alternative to natural wood (plant cellulose) and plastic.

FIG. 2 is a side view of a compression apparatus for use according to the described process.

FIG. 3 is an image of a synthetic wood product produced by the described methods.

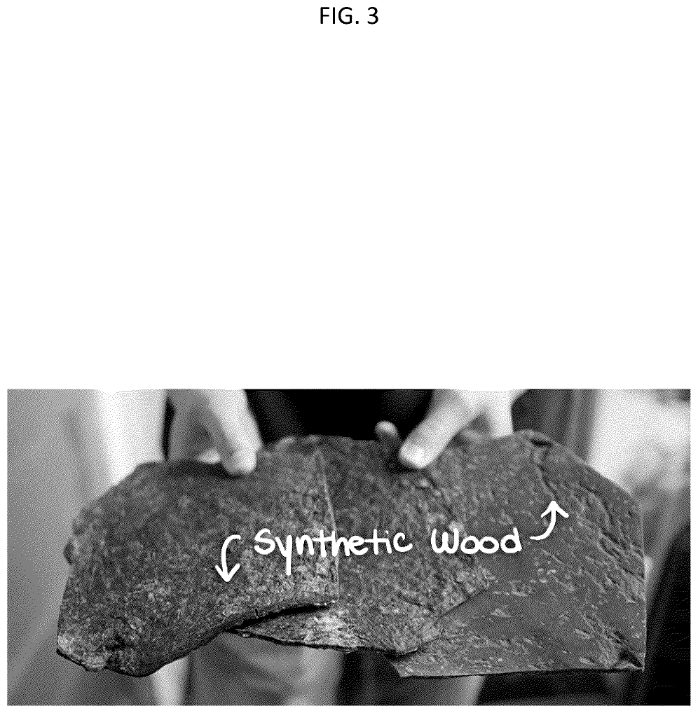

FIG. 4 is an image of an article formed from the synthetic wood product of FIG. 9 according to the described methods.

FIG. 5 depicts another embodiment of a process for producing synthetic wood products as an alternative to natural wood (plant cellulose) and plastic.

FIG. 6 depicts another embodiment for producing synthetic wood products as an alternative to natural wood (plant cellulose) and plastics.

FIG. 7 depicts another embodiment for producing synthetic wood products as an alternative to natural wood (plant cellulose) and plastics.

### DETAILED DESCRIPTION

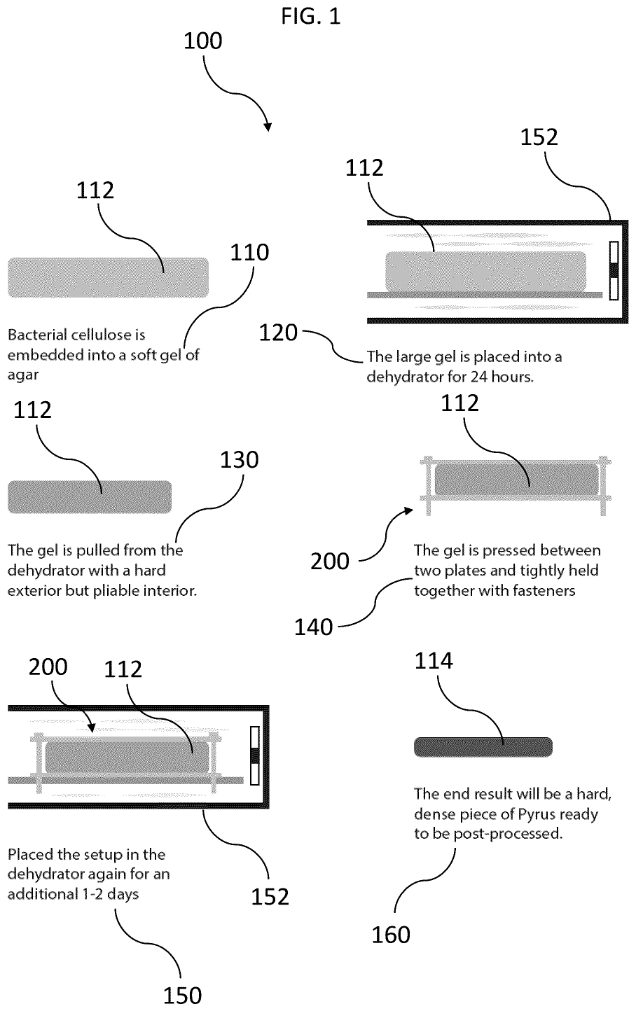

Turning now to FIG. 1, a process for creating a synthetic wood product is shown. The process 100 includes providing bacterial cellulose, mechanically grinding the bacterial cellulose, and mixing the bacterial cellulose with a gel to form a mixture 112. In some instances, binders and/or additives may be incorporated with the mixture, before forming the mixture (e.g., by mixing the bacterial cellulose with the binders and/or additives prior to mixing with the gel), during the formation of the mixture, or after the formation of the mixture. Thereafter the mixture 112 is dewatered for a period of time to remove water and to form a semi-solid mass having a hard exterior with a pliable interior. The semi-solid mass is compressed along a single axis although it is contemplated that the semi-solid mass may be compressed along one, two, or three axes. The compression can be effected using any suitable apparatus. There may be one or more compression steps. While the semi-solid mass is being compressed, the semi-solid mass may be further dehydrated for a period of time to remove all, or substantially all, water or liquid present in the semi-solid mass to form the resulting synthetic wood. The semi-solid mass is then dried after compression by applying heat or other methods of reducing water content (e.g., vacuum, sound waves, microwaves, etc.). In some embodiments, a furfuryl alcohol resin, oil, natural waxes, or shellacs may be applied to the surface of the synthetic wood to increase hydrophobicity.

As noted above, the described process includes providing a bacterial cellulose that, in some embodiments, is mixed with a gel. Generally, bacterial cellulose (BC) is a natural biomaterial synthesized by bacteria. It possesses a unique structure of cellulose nanofiber-weaved three-dimensional reticulated network that endows it with excellent mechanical properties, high water holding capability, and outstanding suspension stability. Bacterial cellulose may be synthesized by a type of bacteria such as, but not limited to, the genera Gluconacetobacter, Aerobacter, Rhizobium, Sarcina, Azotobacter, Agrobacterium, Pseudomonas, and Alcaligenes. Advantageously, bacterial cellulose is free of lignin, hemicellulose, and pectin, which are found in plants and plant-based wood. Moreover, bacterial cellulose has a higher degree of polymerization than plant cellulose and typically has high crystallinity with short disordered sections as intervals, which likely provides high mechanical strength and flexibility properties found in bacterial cellulose. The cellulose can also be synthesized in a cell-free system using components of the above bacteria, including enzymes and co-factors.

Methods of forming bacterial cellulose are known and include static and agitated processes. Typically, the bacterial cellulose (which may have a white or translucent appearance) may be formed under aqueous or liquid conditions in which the liquid comprises from about 80% to about 95% or from about 81%, 82%, 83%, 84%, 85%, 86%, 87%, 88%, 89%, 90%, 91%, 92%, 93%, 94%, or about 95%, or within any range that can be formed from the preceding values. To that end, the described methods of making the synthetic wood may include the use of bacterial cellulose formed by any process. In some embodiments, the method of forming the bacterial cellulose may include the use of bacteria from a waste stream from the production of kombucha, nata de coco, and similar products. Suitable bacteria that may be present in the waste stream from the production of kombucha and that may be useful in the described process include, but are not limited to the Lactobacillus nagelii, Gluconacetobacter, Gluconobacter, and Komagataeibacter species. As an example, a suitable bacterium is Komagataeibacter xylinus. According to at least some embodiments, the bacteria may be selected from a symbiotic culture of bacteria and yeast, or SCOBY culture. In some embodiments, the bacteria may be selected from the genera including Acetobacter, Gluconobacter, and combinations thereof. In some embodiments, the bacteria may be selected from Bacterium gluconicum, Bacterium xylinum, Acetobacter xylinum, Acetobacter xylinoides, Acetobacter ketogenum, and combination thereof. In some embodiments, the yeast may be selected from Saccharomycodes ludwigii, Saccharomycodes apiculatus, Schizosaccharomyces pombe, Zygosaccharomyes, Saccharomyces cerevisiae, and combinations thereof.

Broadly speaking, Komagataeibacter xylinus converts sugars into cellulose sheets. It is generally believed that the biosynthesis of bacterial cellulose occurs in a two-stage process. First, the intracellular polymerization of glucose molecules into cellulose polymers, and second, the self-assembly of cellulose polymer chains into crystalline nanofibers, which self-weave into a three-dimensional network to generate a gelatinous pellicle (also referred to as cellulose sheets). The cellulose sheets grow in water in at least some embodiments, often over the course of multiple days. In other embodiments, additional additives to the water can assist in the growth process.

In some embodiments, the source of sugar (e.g., glucose or fructose) for the bacteria can include food waste, agricultural residues, compost materials, animal waste, waste sawdust from wood processing, grass clippings, tree debris, other sources of organic matter often discarded by other industries, and/or the like, and combinations thereof.

According to at least some embodiments, the bacterial cellulose is formed, ground, and then blended to an even consistency. In some embodiments, the bacterial cellulose is blended while still damp. Alternatively, it is contemplated to form the bacterial cellulose, dry it for later use. In this instance, the dried bacterial cellulose may be crushed or ground (e.g., through blending, ball milling, compression methods, and/or the like) into particulates that may then be mixed with water and/or gel as described below.

In some instances, the bacterial cellulose may be ground with a high-shear or low-shear mechanical grinder. Prior to mixing, it is advantageous to grind the bacterial cellulose into a homogenous mixture to ensure it will form a homogenous suspension with water and any additives.

In some instances, the bacterial cellulose (whether dried or not) may then be mixed with water to form a viscous mixture in which the bacterial cellulose is incoherent and obtains a visual appearance of a brown color. The mixing may be performed using any suitable mixer that will be sufficient to impart significant and complete mixing of the bacterial cellulose in the water to form a homogenous aqueous suspension. In this regard, it is noted that the mixture will contain a ratio of bacterial cellulose to water in a range of about 0.75:1.5 to about 1.5:0.75, by weight. In some instances, the ratio is about 1:1.

The mixing may be conducted at any suitable temperature although in some embodiments, the mixing may be performed at a temperature higher than room temperature. In at least some embodiments, dependent on the content of the water-based solution mixture, this heating occurs over an open flame. In other embodiments, heating occurs in a closed vessel within a heated liquid bath. In further embodiments, inductive heating elements are used either externally or internally to the vessel containing the bacterial cellulose and water mixture. In at least some embodiments, heating may occur up to a temperature of about 70% of the sublimation temperature, but does not extend to the point of boiling. In at least some embodiments, such as when the bacterial cellulose and water mixture is at least 95% water, the mixture may be heated to a temperature ranging from about 80° C. to about 100° C. (so long as the temperature is below the boiling point). To that end, the temperature may be about 80° C., 81, 82, 83, 84, 85, 86, 87, 88, 89, 90, 91, 92, 93, 94, 95, 96, 97, 98, 99, or about 100° C. or within any range that can be formed from the preceding values.

The bacterial cellulose and water mixture may be mixed with a gel and in some instances, the bacterial cellulose may be embedded into the gel. In other instances, the gel may be mixed with water to form a gel solution to which the bacterial cellulose and water mixture (where the bacterial cellulose is dried or as a bacterial cellulose solution), may be combined. In this case, either or both of the gel solution and the bacterial cellulose and water mixture may be heated prior to, during, or after combining.

Suitable gels may include, but are not be limited to agar, algae-based ingredients, organic gelatins, xanthan gum, alginate, carrageen, hydrocolloids such as alginates including sodium alginate and propylene glycol alginate, carrageenans, cellulose gum, colloidal microcrystalline cellulose (MCC), gellan gum, guar gum, gum Arabic, locust bean gum, sargassum and other seaweed-derived binding agents, and/or the like, and combinations thereof. In some embodiments, the gel is agar powder.

The gel may be added in sufficient amounts to provide between about 5% to about 35% of the combined mixture (i.e., the mixture containing the bacterial cellulose, water, binders, and additives). In some instances, the gel may be added in an amount from about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or about 35%, or within any range that can be formed from the preceding values. Where agar powder is used, it is contemplated that it will be present in the combined mixture in amounts between about 15% and about 20% with respect to the amount of bacterial cellulose in the combined mixture.

According to at least some embodiments, it is contemplated to include one or more binders before, during, or after mixing the bacterial cellulose and water mixture with the gel or gel solution. It is contemplated that the binder may be added mixed with water (with or without heating) prior to adding. A plurality of binders are contemplated and may include, but are not limited to, guar gum, ammonium lignosulfonate, chitosan, lignin, arrowroot, cassava, tapioca, yucca, manioc, organic starches including potato starch, pectin, [poly (Acrylic acid-co-N-Methylol Acrylamide-co-Butyl Acrylate) Copolymer Grafted Carboxymethyl Cellulose], soy proteins, polyacrylic acids, liquid plant hydrolysate, magnesium oxide, xanthan gum, agar, seaweed extracts, kelp, sulfite liquor, wheat flour, sucrose, and similar compounds and combinations thereof.

According to at least some embodiments, it is contemplated to include one or more additives before, during, or after mixing the bacterial cellulose and water mixture with the gel or gel solution. The additive or additives may be chosen to adjust or improve the physical properties of the resulting synthetic wood. Such properties include hydrophobicity, which can be improved through additives such as polyhydroxyalkanoate (PHA), polylactide (PLA), polybutylene adipate terephthalate (PBAT), polybutyl succinate (PBS), cellophane, glycerol monostearate, shellac and other natural finishes, waxes, natural gums, oils derived from natural sources or alteration of synthetic materials including cedar oil, cypress oil, juniper oil, teak oil, tung oil, flax oil, linseed oil, coffee oil and other natural oils, natural resins, menthol crystals, proteins, including soy protein isolate and mushroom powder, and zein. In some embodiments, the oils may be blended with water in a vacuum to form an emulsion, prior to adding to the material, or applied to the surface of the finished product. Other additives such as a dye or colorant may be added. Similarly, it has been contemplated that glycerin or other alcohol or polyol may be added at any time prior to compressing the semi-solid mass.

Other such properties which the additives may be chosen to adjust include stiffness or rigidity of the finished plank through additives such as ground stone or other mineral materials. Additionally or alternatively, fiber may be added to improve stiffness or rigidity, such as plant fibers or other industrial fibers. Waste agricultural fibers can include bagasse, wheat straw, hemp straw, flax, rice hulls, jute, kenaf, bamboo, coconut, or numerous other fibers, and/or the like, and combinations thereof. These additional materials can be processed to reduce the length or thickness of the fibers prior to adding them to the blended material, prior to molding. Such fibers may be obtained from waste industrial processes, waste animal processing products, or fibers obtained from insects include spider or caterpillar fibers such as silk, or other similar fibers.

Tannins or tannin-rich compounds, such as tara, quebracho, mimosa, chestnut, oak, hemlock, and myrobalan powder, and/or the like, and combinations thereof may be added to boost hydrophobicity and dye absorption.

Borax, boric acid, and/or the like, and combinations thereof may be added to the blended material prior to molding in order to increase the fire retardancy. In another embodiment, these compounds are applied to the surface of the finished material.

In some embodiments, an additional property, the modulus of rupture, may be modified by the addition of gels which may include, but are not be limited to agar, algae-based ingredients, organic gelatins, xanthan gum, hydrocolloids such as alginates including sodium alginate and propylene glycol alginate, carrageenans, cellulose gum, colloidal microcrystalline cellulose (MCC), gellan gum, guar gum, gum Arabic, locust bean gum, sargassum and other seaweed-derived binding agents, and/or the like, and combinations thereof.

The combining of the bacterial cellulose, gel, binder, and additive may be effected with continual or intermittent stirring and with the application of heat to provide a slurry that, in some instances, presents a faded green visual appearance. According to at least some embodiments, the combining may be effected using a mechanical apparatus such as an industrial mixer for a period of time to ensure even distribution of all ingredients and to improve the mechanical integrity of the final product. The period of time may range from one to several hours. The combined mixture exhibits a linear or first order exponentially reduced viscosity as heat is applied. In some instances, the combined mixture is heated to the approximate gelling temperature of the gel being used. For example, where the gel is agar, the combined mixture may be heated to a temperature between about 32° C. to about 45° C.

Referring back to FIG. 1, after the combined mixture containing the bacterial cellulose and gel (and any binder or additive) is formed, the combined mixture may be cooled in place or may be transferred to one or more molds of any suitable structure such that the mold is capable of retaining the combined mixture. It will be appreciated that as the combined mixture cools, for example, at room temperature, it will begin to form into a semi-solid formed mass. It will also be appreciated that as the combined mixture cools at room temperature, it will be dehydrated as water evaporates from the combined mixture.

Additionally or alternatively, the combined mixture may be subjected to a dewatering step. The dewatering step may be completed by wet classification, centrifugation, filtration, or similar solid-liquid separation processes, such as removal of residual liquid from a filter cake by a filter press. The dewatering may occur for a period of time ranging from about 2 hours to about 100 hours, or from about 2 hours to about 50 hours, or from about 2 hours to about 25 hours or from about 2 hours to about 10 hours. The residual water content in the combined mixture may range from about 1% w/v to about 50% w/v, from about 1% w/v to about 25% w/v, from about 1% w/v to about 20% w/v, from about 1% w/v to about 15% w/v, from about 1% w/v to about 10% w/v, from about 1% w/v to about 5% w/v, from about 1% w/v to about 4% w/v, from about 1% w/v to about 3% w/v, or from about 1% w/v to about 2% w/v. In some embodiments, the dewatering may occur in a centrifuge at speeds of about 0 rpm to about 500 rpm, from about 500 rpm to about 1000 rpm, from about 1000 rpm to about 1500 rpm, from about 1500 rpm to about 5000 rpm, or from about 3000 rpm to about 4000 rpm. The combined mixture should not be dewatered to the extent that individual fibers begin to agglomerate. As such, the timing of the dewatering step must be monitored closely.

Additionally or alternatively, the combined mixture may be subjected to other forms of dehydration under suitable conditions and for a suitable period of time to remove a significant amount of water and/or liquid present in the mixture to form a semi-solid mass that has a dark appearance, is dense, and exhibits a hard outer surface. The combined mixture may be dehydrated using any suitable method or apparatus such as but not limited to driers (tunnel, kiln, cabinet, vacuum, drum, roller, etc.), microwaves, infrared apparatuses, electrostatic apparatuses, sonic apparatuses, and the like. The dehydration may occur at any suitable temperature such as between about 35° C. to about 90° C. or a maximum of about 85° C., 80° C., 75° C., 70° C., 65° C., 60° C., 55° C., or about 50° C. The dehydration (drying) may occur for a period of time ranging from about 4 hours to about 200 hours, or from about 12 hours to about 150 hours, or from about 24 hours to about 100 hours or from about 48 hours to about 70 hours. In some instances, the dehydration (drying) is conducted in a step-wise manner such that the initial dehydration parameters (e.g., temperature and humidity) are controlled to ensure an even and steady evaporation of water and, after a pre-determined period of time, the temperature may be increased and the humidity may be decreased in one or more steps until completion of the drying. In this regard, the initial temperature typically will not exceed 50° C. and will not exceed an average humidity between about 40% to about 60%, or within any range that can be formed from the preceding values.

Turning back to FIG. 1, the semi-solid mass is then subjected to compression for a period of time and at a selected temperature to achieve a desired thickness and residual water content for the resulting synthetic wood. The desired thickness may range from about 1 mm to about 25 cm, or from about 1 cm to about 10 cm, or from about 1, 2, 3, 4, 5, 6, 7, 8, 9, or about 10 cm. Prior to compression, the residual water content may range from about 1% w/v to about 50% w/v, from about 1% w/v to about 40% w/v, from about 1% w/v to about 30% w/v, from about 1% w/v to about 25% w/v, from about 1% w/v to about 24% w/v, from about 1% w/v to about 23% w/v, from about 1% w/v to about 22% w/v, from about 1% w/v to about 21% w/v, or from about 1% w/v to about 20% w/v. After compression, the residual water content may range from about 1% w/v to about 20% w/v, from about 1% w/v to about 10% w/v, from about 1% w/v to about 9% w/v, from about 1% w/v to about 8% w/v, from about 1% w/v to about 7% w/v, from about 1% w/v to about 6% w/v, from about 1% w/v to about 5% w/v, from about 1% w/v to about 4% w/v, from about 1% w/v to about 3% w/v, or from about 1% w/v to about 2% w/v. In some embodiments, electro-dewatering is incorporated by electrifying the compression mold.

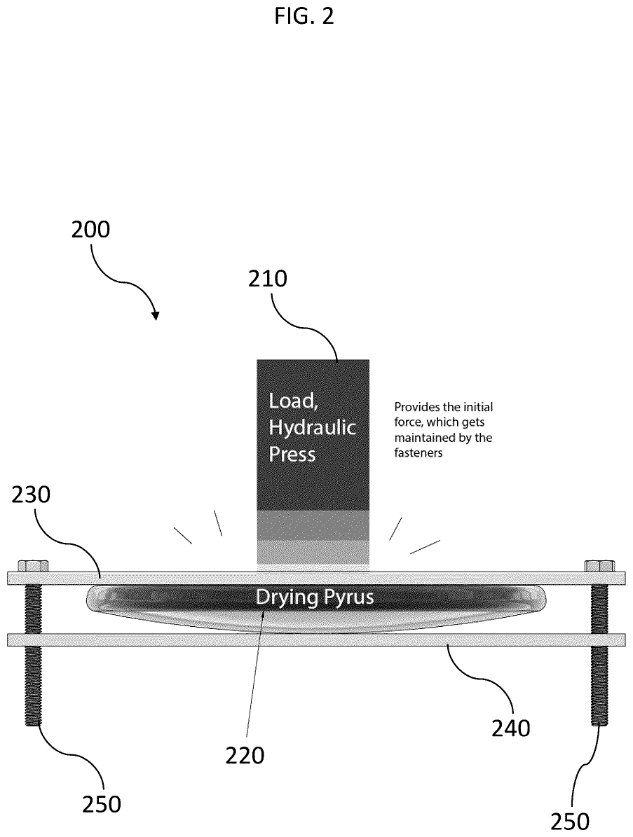

Decreasing the amount of residual water content via compression of the semi-solid mass decreases the likelihood of voids forming in the compressed semi-solid mass. The compression may be effected along a single axis, although it is contemplated that the semi-solid mass may be compressed along one, two, or three axes. The compression can be effected using any suitable apparatus. In one instance, the compression may be effected by compressing the semi-solid mass between two opposed plates (that may be formed of metal or other materials) that may be clamped together in a manner permitting an increase and decrease in the compression force applied to the semi-solid mass. As shown in FIG. 2, the compression force may be maintained or varied by a combination of a hydraulic press 210, metal plates 230 and 240, and retainers 250. According to at least some embodiments, other press methods may be used, including but not limited to precision hydraulic presses 210, centrifugal presses, and pneumatic mass presses.

In an exemplary embodiment, the semi-solid mass's void content is reduced through compression. The term void refers to unfilled or empty spaces that may impact the material's structural integrity or appearance. Void content refers to the amount of fluid-filled cavities contained within the semi-solid mass. Increasing the compressive force during the compression step may decrease the void content. Reducing the void content may increase the structural rigidity of the semi-solid mass. In this embodiment, the compression can be effected using any suitable apparatus. In one instance, the compression may be effected by compressing the semi-solid mass between two opposed plates (that may be formed of metal or other materials) that may be clamped together in a manner permitting an increase and decrease in the compression force applied to the semi-solid mass. As shown in FIG. 2, the compression force may be maintained or varied by a combination of a hydraulic press 210, metal plates 230 and 240, and retainers 250. According to at least some embodiments, other press methods may be used, including but not limited to precision hydraulic presses 210, centrifugal presses, and pneumatic mass presses. The void content of may range from about 0.5% v/v to about 5% v/v, from about 0.6% v/v to about 5% v/v, from about 0.7% v/v to about 5% v/v, from about 0.8% v/v to about 5% v/v, from about 0.9% v/v to about 1% v/v, from about 1% v/v to about 5% v/v, from about 2% v/v to about 5% v/v, from about 3% v/v to about 5% v/v, from about 4% v/v to about 5% v/v, or within any range that can be formed from the preceding values.

In some embodiments, it is contemplated that the compression may be conducted at room temperature. Alternatively, it is contemplated to further dehydrate the semi-solid mass while under compression by subjecting the semi-solid mass to a finish drying process to remove all or substantially all the water present to provide a finished synthetic wood product having less than 20% water, or less than 19%, 18%, 17%, 16%, 15%, 14%, 13%, 12%, 11%, 10%, 9%, 8%, 7%, 6%, 5%, 4%, 3%, 2%, 1%, 0.5%, or less than about 0.1% water. In other or the same embodiments, a second compression step may be employed compressing the semi-solid mass at a higher pressure to further remove residual water. The multiple compression steps create corresponding densities in the semi-solid mass that can mimic those of a variety of tree-derived woods.

In some embodiments, the compression may not be necessary. After the dewatering step, the combined mixture may already have less than 5% water, or less than 4%, 3%, 2%, 1%, 0.5%, or less than about 0.1% water. In such instances, a compression step is not necessary.

After compression, drying may be effected at a temperature ranging from about 50° C. to about 90° C., or about 50° C., 55° C., 60° C., 65° C., 70° C., 75° C., 80° C., 85° C., to about 90° C., or within any range that can be formed from the preceding values for a period of time ranging from about 4 hours to about 100 hours or about 12 hours to about 50 hours, or within any range that can be formed from the preceding values. The compression and drying may be performed simultaneously and it will be appreciated that the drying may use lower temperatures for longer periods of time or higher temperatures for shorter periods of time. Upon completion of the compression and drying step, the resulting synthetic wood will be formed.

In one embodiment, a constraint system is used to generate force on one or more of the 6 sides of the plank while it is dried, so as to constrain warping, twisting or bending during the shrinking that occurs while the plank dries. The constraint system comprises a number of extension springs attached to pressing plates or bars, which surround the plank. In another embodiment, a mechanical mold is used to apply force on only one side, while the other sides remain static. In yet another embodiment, the force exerted on one side of the plank is achieved by a static weight.

In at least some embodiments, the synthetic wood has a consistency, hardness, and flexibility allowing it to be easily and precisely cut using precision fabrication tools like laser cutters and CNC machines. Using various curing (drying or dehydration) techniques deployed in some embodiments, the material 114 can be made to resemble high-value woods, i.e., those woods available in limited supply and/or are or are typically sourced by logging that is known to cause forest degradation and likely precipitate deforestation or other environmental concerns.

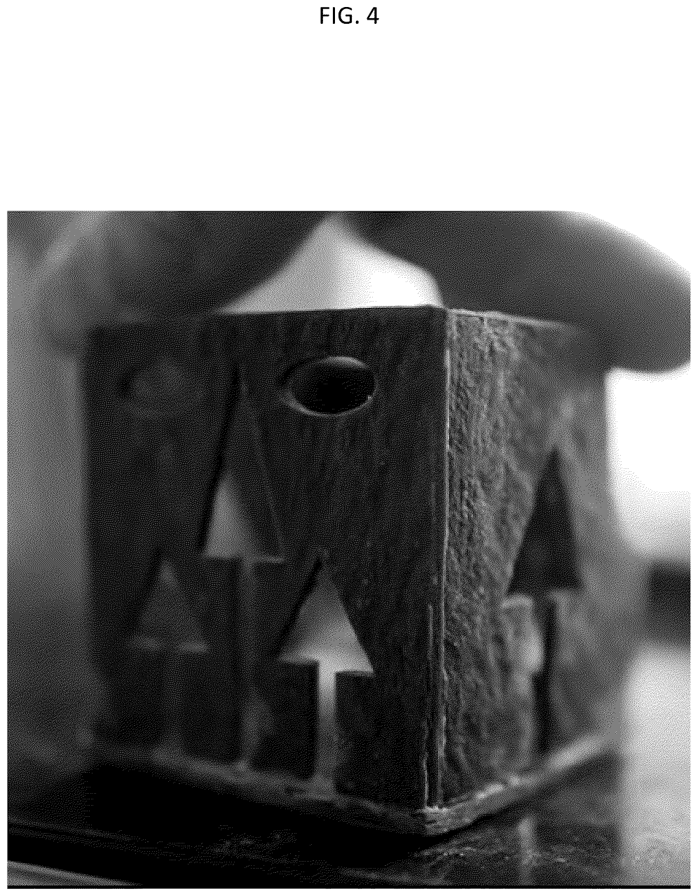

The synthetic wood can be used to create wood-like products including but not limited to small wood-like products, such as guitar picks and jewelry. In other embodiments, the synthetic wood can be used for cabinet making, toys, turning blanks, sculptures, veneers, kitchen decor, instruments, flooring, veneers, plywoods, and other items crafted from tree-based wood such as shown in FIG. 4. The synthetic wood formed according to the described methods contains a three-dimensional matrix of cellulose and gel that is stable at room temperature. Unlike a pure bacterial cellulose material, the synthetic wood according to the described methods is more stable under high-moisture conditions.

It is contemplated that the exterior surface of the synthetic wood may be coated with a finish, such as a wood finish, including but not limited to nitrocellulose lacquer or polyurethane based finishes. In such embodiments, the water resistance of the compound is improved. In some embodiments, the wood finish includes an evaporative wood finish, which dries via solvent evaporation (e.g., shellac, nitrocellulose lacquers, wax). In some embodiments, the wood finish includes a reactive wood finish, which cures via a chemical reaction (e.g., polyurethane varnish). In further embodiments, the wood finish includes a coalescing wood finish, which dries by both chemical reaction and solvent evaporation (e.g., water-based finishes, such as latex paint). The skilled artisan will appreciate that the above coatings and other various methods may be used to increase the water resistance of the resulting synthetic wood.

In some embodiments, a furfuryl alcohol resin is formed on the surface of the synthetic wood. The furfuryl alcohol resin increases hydrophobicity. To create the furfuryl alcohol resin on the surface of the synthetic wood, furfuryl alcohol is combined with distilled water in a concentration ranging from about 15% v/v to about 75% v/v. In other embodiments, the concentration may range from about 15% v/v to about 20% v/v, from about 15% v/v to about 30% v/v, from about 15% v/v to about 40% w/v, from about 15% v/v to about 50% v/v, from about 15% v/v to about 60% v/v, or from about 15% v/v to about 70% v/v. In some embodiments, less than 1% v/v of borax may be added to the furfuryl alcohol mixture to control reactivity of the acidic catalysts during furfurylation. In some embodiments, 1.75% v/v compound catalyst of 1.15% citric acid and 0.06% oxalic acid is added to reduce the pH of the furfuryl alcohol mixture. A plank of synthetic wood is submerged in this mixture, in some embodiments under pressure, and left for at least 24 hours. Following the soaking, the synthetic wood is removed, wrapped in a nonpermeable heat-resistant material, and cured for 8 hours in an oven at 105 degrees Celsius.

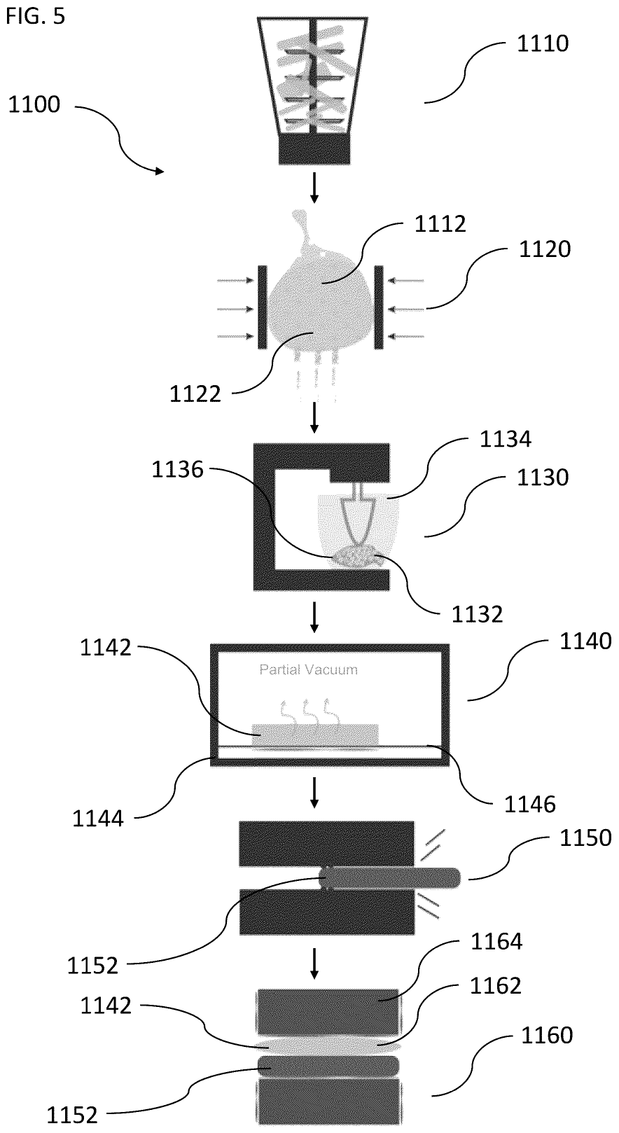

Turning now to FIG. 5, a schematic view of a process for creating a synthetic wood from bacterial cellulose as an alternative to woods (plant cellulose) and plastics is shown. In this embodiment, bacterial cellulose is provided and blended to an even consistency 1110. According to at least some variants, the bacterial cellulose can be formed from waste materials produced by manufacturing processes within the kombucha industry. However, it is contemplated that the bacterial cellulose may be provided by any suitable method or source. The blending step can be accomplished using a kitchen blender, although for commercial applications, other methods of blending such as ball milling and other industrial pulverization methods may be used to produce a blended mixture 1112.

Subsequently, the blended mixture may be compressed. The compression may be along a single axis or may be along one two, or three axes, as described above. In the illustrated embodiment, the compression may be conducted while the blended mixture 1112 is contained by a strainer or a filter 1122 that is permeable to water, but not to the solid mass of the blended mixture. According to at least some iterations of this embodiment, after the compression, approximately 15% of the mass of blended mixture 1112 remains as a condensed mixture 1132. According to at least some embodiments, the condensed mixture 1132 has flour-dough-like consistency. The condensed mixture 1132 is then worked or mixed to an even consistency in an apparatus known to mix soft solids, such as an industrial mixer 1134 at step 1130.

An additive 1136 such as those described above may be added to the condensed mixture before, during, or after the condensed mixture is worked or mixed. Typically, the additive is added before or during the working or mixing of the condensed mixture. In at least one embodiment, the additive material is guar gum. The guar gum may be added as a powder or a solution. The guar gum may be added in an amount from about 0.5% to about 5% of the mass of the condensed mixture to create a precursor mixture 1142. In some instances, the guar gum is added in an amount from about 0.5%, 0.6%, 0.7%, 0.8%, 0.9%, 1%, 2%, 3%, 4%, or about 5%, or within any range that can be formed from the preceding values.

According to other embodiments, the additive material 1136 may be a gel material including a hydrocolloid which, in some embodiments, may include one or more of alginates (e.g., sodium alginate, propylene glycol alginate), carrageenans, cellulose gum, colloidal microcrystalline cellulose (MCC), gellan gum, gum Arabic, locust bean gum, xanthan gum, and/or the like, and combinations thereof. According to other or the same embodiments, the additive can be chitosan, ammonium lignosulfonate, or a combination thereof. In at least one embodiment the additive material may be a combination of chitosan and ammonium lignosulfonate. In this instance, the chitosan may be added as an approximately 4% molecular weight solutions and the ammonium lignosulfonate may be added as an approximate 49% aqueous solution at approximate. The chitosan and ammonium lignosulfonate may be added to the condensed mixture in an amount such that each of the chitosan and ammonium lignosulfonate are present at about 5% to about 20% of the mass of the condensed mixture. In some instances, each of the chitosan and ammonium lignosulfonate are present at about 5%, 6%, 7%, 8%, 9%, 10%, 11%, 12%, 13%, 14%, 15%, 16%, 17%, 18%, 19% or about 20%, or within any range that can be formed from the preceding values or the mass of the condensed mixture.

The precursor material, which is a semi-solid material, may then be subjected to compression using the same or similar compression apparatuses described above and in the same manner as described above, while being subjected to a vacuum kiln to dehydrate or dry the precursor material to remove all or significantly all of the water or moisture (to the same levels as noted above). According to some embodiments of step 1144, the vacuum kiln 1144 develops a vacuum of at least twenty inches of mercury while the kiln is heated to a temperature of approximately 125° F., though these parameters may be adjusted according to the volume of the kiln 1144 and the composition of the precursor mixture 1142 amongst other parameters. In this regard, both the vacuum and the temperature are selected to minimize cracking of the precursor mixture throughout the drying process to form a raw synthetic wood

The raw synthetic wood may then be sanded, planed or otherwise resurfaced at step 1150, to remove surface imperfections such as apertures. Thereafter, in a final finishing step 1160, in some embodiments, a new outer surface 1162, consisting of a thin layer precursor mixture 1142 is added to one or more exterior surfaces of the raw synthetic wood after which, materials are compressed and further dried as above in step 1140.

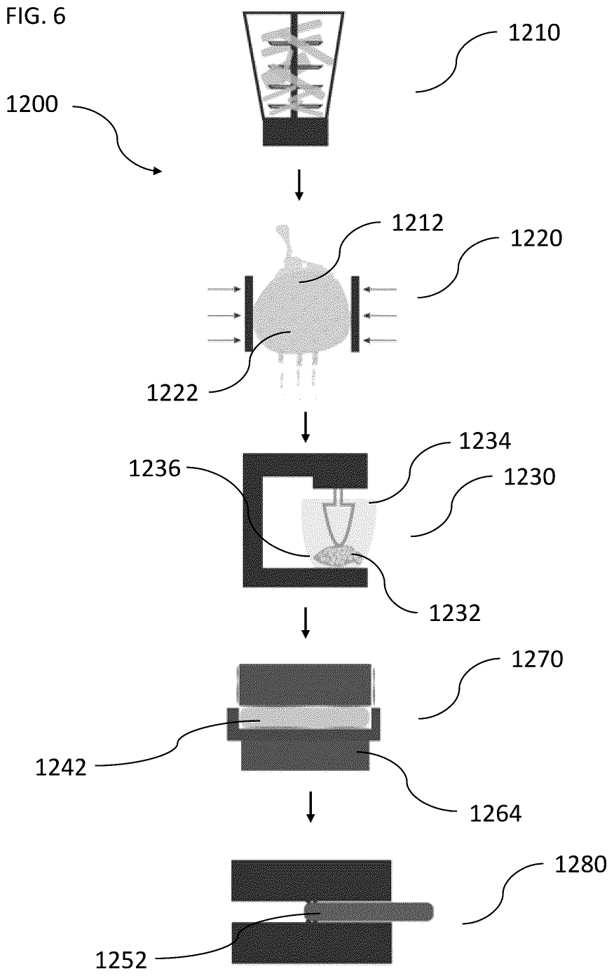

FIG. 6 shows a schematic view of a process for creating a synthetic wood from bacterial cellulose as an alternative to woods (plant cellulose) and plastics 1200. It will be appreciated that the process depicted in FIG. 6 is generally the same as that shown in FIG. 5 with the following differences. The process according to FIG. 6 may or may not include vacuum drying and it does not include a step of adding to one or more exterior surfaces of a raw synthetic wood a layer of precursor mixture. In this regard, if vacuum drying is not used, an alternative such as an enclosed heat press 1264 may be used, which is capable of reducing the drying time compared to other described embodiments. The enclosed heat press is an apparatus that is configured to retain the precursor mixture within a specified boundary while compression and heat are applied. The result is unfinished or raw synthetic wood, which may then be sanded, planed or otherwise resurfaced at step 1280 to remove surface imperfections such as apertures.

According to at least some embodiments, a bacterial cellulose need not be blended or otherwise pulverized. In at least some of such embodiments, bacterial cellulose can be grown in large vats or other containers that are greater in size than the desired wood substitute sample to be produced. The cellulose can grow in sheets in these vats, and be cut to size based on the wood substitute sample to be produced. In some embodiments the sheets can be coated in a binder, such as those mentioned elsewhere in this disclosure. These sheets can then be stacked, compressed in a hydraulic or pneumatic press, and dried in a heat press or vacuum kiln. According to at least some of such embodiments, these compressed sheets maintain the tensile strength naturally present in bacterial cellulose.

According to at least some embodiments, bacterial cellulose can be blended, dried, and then ground into a fine dust or powder, prior to curing in a heat press, vacuum kiln, oven, dehydrator, or air dryer. According to at least some of such embodiments, this technique can minimize shrinking in the drying process. According to at least some of such embodiments a dust or fine powder of bacterial cellulose, or a mixture thereof with binders or additives disclosed herein, can be utilized in connection with an additive manufacturing process such as 3D printing and binder jet 3D printing.

In at least some embodiments, bacterial cellulose can be produced with a binder included in the cellulose generation process. According to at least some embodiments, a fermentation vessel is inoculated to initiate bacterial cellulose growth. Lignosulfonate or other lignin derivatives can be added to the fermentation vessel to fuel bacteria growth. Cellulose is then allowed to grow in some embodiments over a period of days, and then cellulose infused with the additive lignosulfonate is removed from the vessel. According to other or the same embodiments, other additives listed herein can be used. In at least some embodiments, cellulose that is infused can then be soaked in a reducing agent. According to at least some embodiments, reducing agents can include acids such as ascorbic acid or other such agents disclosed herein.

In another alternative, the bacterial cellulose (formed by any suitable manner) may be blended in an aqueous solution to which a pH modulating agent may be added to modulate the pH of the solution so that the pH of the solution is between about 7.0 and 8.0. The pH modulating agent may be any ingredient suitable for modulating the pH and exemplary ingredients include, but are not limited to sodium hydroxide, potassium hydroxide, magnesium hydroxide, calcium hydroxide, sodium bicarbonate, potassium bicarbonate, magnesium carbonate, calcium carbonate, and mixtures thereof. Thereafter, the water or liquid is removed from the solution to form a semi-solid mass.

The semi-solid mass may then be treated with one or more fungi, by injecting a fungus solution into the semi-solid mass or by coating the exterior surface of the semi-solid mass, or both. The fungus may be any suitable fungus such as yeast, mold, mushrooms, and mixtures thereof. In one instance, the fungus is a mushroom such as a pearl oyster mushroom. The treated semi-solid mass is allowed to cure over a period of time so that a mycelium root network propagates and hydrophobic proteins are incorporated into the cellulose structure, which will reinforce the resulting synthetic wood and provide water resistance, respectively. The period of time may range from 1 day to 28 days, or from 1, 2, 3, 4, 5, 6, 7, 8, 8, 10, 11, 12, 13, 14, 15, 16, 17, 18, 19, 20, 21, 22, 23, 24, 25, 26, 27, or 28 days.

Upon completion of the curing, the cured semi-solid mass may be pasteurized to terminate the growth of the fungus and to form the synthetic wood. Pasteurization may be accomplished in any suitable manner such as by heating the cured semi-solid mass at a high temperature for a period of time sufficient to terminate the fungus. A suitable temperature may range from about 80° C. to about 120° C. and a suitable period of time may range from about 1 second to about 120 seconds.

After pasteurization, it is contemplated that the material may be compressed to the desired final shape, as described above, and dehydrated to remove any remaining residual water to form the synthetic wood.

Colors and sizes shown in drawings presented herewith are representative. However, in some embodiments, the agar, water-based solution, and cellulose combination may initially have a light brown color. In such embodiments, agar, water-based solution, and cellulose combination may turn a darker beige and shrink during a first drying session, ultimately shrinking further throughout the method disclosed herein to resemble a dark brown color.

It will be appreciated that, according to the above-described methods, a synthetic wood product having suitable and desirable physical properties can be formed. The synthetic wood comprises bacterial cellulose and a gel. The gel may be selected from agar, algae-based ingredients, organic gelatins, xanthan gum, hydrocolloids such as alginates including sodium alginate and propylene glycol alginate, carrageenans, cellulose gum, colloidal microcrystalline cellulose (MCC), gellan gum, guar gum, gum Arabic, locust bean gum, and/or the like, and combinations thereof. In some embodiments, the synthetic wood may include one or more binders and additives.

When binders are included, they may be selected from guar gum, arrowroot, cassava, tapioca, yucca, manioc, organic starches including potato starch, pectin, [poly (Acrylic acid-co-N-Methylol Acrylamide-co-Butyl Acrylate) Copolymer Grafted Carboxymethyl Cellulose], soy proteins, polyacrylic acids, liquid plant hydrolysate, magnesium oxide, xanthan gum, agar, seaweed extracts, kelp, sulfite liquor, wheat flour, sucrose, chitosan, and similar compounds and combinations thereof. Binders may further be selected from lignin and assorted derivatives thereof such as ammonium lignosulfonate, calcium lignosulfonate, sodium lignosulfonate, magnesium lignosulfonate, and ferrous lignosulfonate, kraft lignin, organosolv lignin, and similar compounds and combinations thereof.

When additives are included, they may be selected from polyhydroxyalkanoate (PHA), polylactide (PLA), polybutylene adipate terephthalate (PBAT), polybutyl succinate (PBS), cellophane, glycerol monostearate, shellac and other natural finishes, waxes, natural gums, castor oil and similar natural oils such as flax and linseed oil, natural resins, menthol crystals, zein, dyes, colorants, glycerin, alcohols, polyols, and combinations thereof.

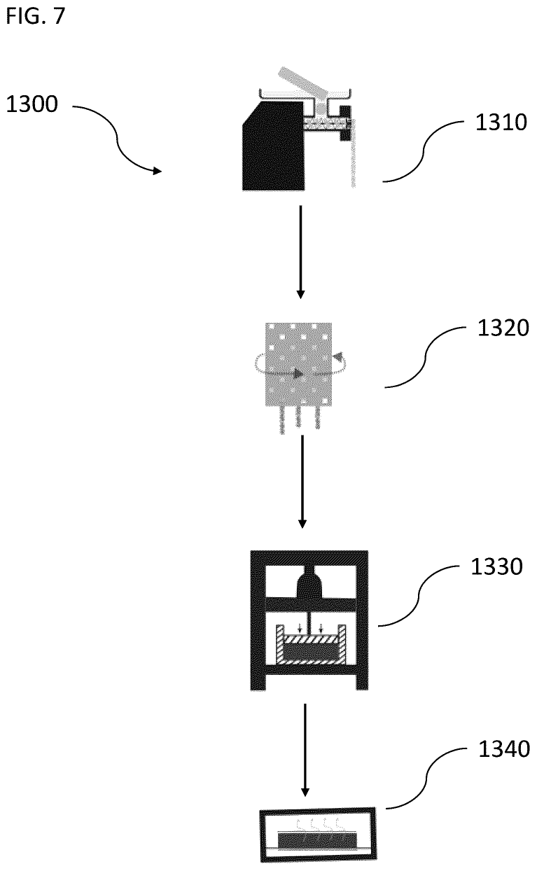

Turning now to FIG. 7, a process for creating a synthetic wood product is shown. The process 1300 includes providing bacterial cellulose, mechanically grinding the bacterial cellulose, and mixing the bacterial cellulose with a gel to form a mixture and at least one additive 1310. In some instances, multiple binders and/or additives may be incorporated with the mixture, before forming the mixture (e.g., by mixing the bacterial cellulose with the binders and/or additives prior to mixing with the gel), during the formation of the mixture, or after the formation of the mixture. Thereafter the mixture is dewatered via centrifugation 1320 to remove water and to form a semi-solid mass having a hard exterior with a pliable interior. The semi-solid mass is compressed 1330 along a single axis although it is contemplated that the semi-solid mass may be compressed along one, two, or three axes. The compression can be effected using any suitable apparatus. There may be one or more compression steps. While the semi-solid mass is being compressed, the semi-solid mass may be further dehydrated for a period of time to remove all, or substantially all, liquid water present in the semi-solid mass. This forms the synthetic wood. The semi-solid mass is then dried after compression by applying heat 1340. In some embodiments, a furfuryl alcohol resin is applied to the surface of the synthetic wood to increase hydrophobicity.

Below, outlined is material property data showing the density and the stiffness of the synthetic wood product produced in accordance with a method claimed herein.

In the compression graph shown in Graph 1, each line here represents a sample of synthetic wood being crushed from above and below over a certain amount of time.

TABLE 1
Compression Testing Data.

| | Compressive | Compressive Yield | | | | |
|---|---|---|---|---|---|---|
| | Strength | Strength | Thickness | Width | Specimen | Height |
| | (MPa) | (MPa) | (mm) | (mm) | label | (mm) |
| NCS_1 | 209 | 209 | 9.1 | 9.16 | NCS_1 | 4.39 |
| NCS_2 | 204 | 204 | 9.05 | 9.21 | NCS_2 | 4.45 |
| NCS_3 | 220 | 220 | 9.02 | 9.09 | NCS3 | 4.36 |
| NCS_4 | 211 | 211 | 9 | 9.06 | NCS4 | 4.4 |
| NCS_5 | 227 | 227 | 9.01 | 8.99 | NCS5 | 4.41 |
| NCS_6 | 195 | 195 | 9.06 | 8.98 | NCS6 | 4.42 |
| NCS_7 | 200 | 200 | 8.98 | 9.03 | NCS7 | 4.42 |

In the stiffness data shown in Graph 2, each line here represents a rectangular sample of synthetic wood being bent at three points. This test is how stiffness is determined.

TABLE 2
Stiffness Testing Data.

| | Modulus (Automatic | | Flexure stress at |
|---|---|---|---|
| | Young's) | Data point at | Yield (Zero slope) |
| | (MPa) | Yield (Zero slope) | (MPa) |
| SBS_1 | 5783.49 | 1110 | 113.96 |
| SBS_2 | 5141.84 | 1092 | 82.2 |
| NBS_1 | 4935.74 | 1117 | 87.76 |
| NBS_2 | 5201.37 | 680 | 82.36 |
| NBS_3 | 4429.82 | 704 | 73.97 |
| NBS_4 | 4985.34 | 714 | 78.73 |
| NBS_5 | 6841.1 | 667 | 73.29 |

The tensile test, shown in Graph 3, represents a sample of synthetic wood being pulled apart at both ends.

TABLE 3
Tension Testing Data.

| | Tensile stress | Tensile strain | Tensile stress | Tensile | Tensile | |
|---|---|---|---|---|---|---|
| | at Yield (Zero | at Yield (Zero | at Maximum | stress at | strain at | Test |
| | slope) | slope) | Force | Break | Break | Speed |
| | (MPa) | (%) | (MPa) | (MPa) | (%) | (mm/min) |
| TfLS_1 | 28.18 | 0.73 | 28.18 | 10.47 | 1.37 | 5 |
| TfLS_2 | 42.19 | 1.88 | 42.19 | 41.67 | 1.94 | 5 |
| TfLS_3 | 12.6 | 1 | 14.99 | 13.94 | 2.7 | 5 |
| TfLS_4 | 19.46 | 1.83 | 19.46 | 11.75 | 2.22 | 5 |
| TfLS_5 | — | — | 54.13 | 54.13 | 3.48 | 5 |
| TfLS_6 | 50.12 | 1.63 | 50.12 | 49.56 | 1.68 | 5 |
| TfLS_7 | 49.88 | 1.99 | 49.88 | 38.67 | 2.34 | 5 |
| TfLS_8 | 20.17 | 1.19 | 20.17 | 7.09 | 3.51 | 5 |
| TfLS_9 | 45.49 | 1.99 | 45.49 | 38.18 | 2.03 | 5 |

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1. A synthetic wood comprising compressed nanocellulose and having a void content.

2. The synthetic wood of claim 1 further comprising a gel, wherein the gel is selected from agar, organic gelatins, xanthan gum, alginate, carrageen, hydrocolloids, sodium alginate, propylene glycol alginate, carrageenan, cellulose gum, microcrystalline cellulose (MCC), gellan gum, guar gum, gum Arabic, locust bean gum, sargassum, seaweed-derived gels, and mixtures thereof.

3. The synthetic wood of claim 1 comprising residual water in an amount less than about 20%.

4. The synthetic wood of claim 1, wherein the additive is selected from the group consisting of: a fire retardant additive, a stiffness additive, a modulus of rupture additive, a hydrophobicity additive, a binder, a dye, or a dye absorption additive.

5. The synthetic wood of claim 4 wherein the binder is selected from guar gum, ammonium lignosulfonate, chitosan, lignin, arrowroot, cassava, tapioca, yucca, manioc, organic starch, potato starch, pectin, [poly (Acrylic acid-co-N-Methylol Acrylamide-co-Butyl Acrylate) Copolymer Grafted Carboxymethyl Cellulose], soy protein, polyacrylic acid, liquid plant hydrolysate, magnesium oxide, xanthan gum, agar, sargassum seaweed extract, kelp, sulfite liquor, wheat flour, sucrose, and mixtures thereof.

6. The synthetic wood of claim 1 wherein the additive is selected from polyhydroxyalkanoate (PHA), polylactide (PLA), polybutylene adipate terephthalate (PBAT), polybutyl succinate (PBS), cellophane, glycerol monostearate, shellac, wax, natural gum, castor oil, flax oil, linseed oil, menthol crystals, zein, dyes, colorants, glycerin, alcohols, polyols, and mixtures thereof.

7. The synthetic wood of claim 1, wherein the void content may range from about 0.5% v/v to about 5% v/v, from about 0.6% v/v to about 5% v/v, from about 0.7% v/v to about 5% v/v, from about 0.8% v/v to about 5% v/v, from about 0.9% v/v to about 1% v/v, from about 1% v/v to about 5% v/v, from about 2% v/v to about 5% v/v, from about 3% v/v to about 5% v/v.

8. A method for producing synthetic wood product having a void content comprising:
providing bacterial cellulose;
combining the bacterial cellulose with a gel to form a mixture;
dewatering the mixture to form a semi-solid mass;
compressing the semi-solid mass; and
dehydrating the compressed semi-solid mass to remove water present in the compressed semi-solid mass and to form the synthetic wood.

9. The method of claim 8 wherein the bacterial cellulose is a solid dry product.

10. The method of claim 8 wherein the gel is selected from agar, organic gelatins, xanthan gum, alginate, carrageen, hydrocolloids, sodium alginate, propylene glycol alginate, carrageenan, cellulose gum, microcrystalline cellulose (MCC), gellan gum, guar gum, gum Arabic, locust bean gum, sargassum, seaweed-derived gels, and mixtures thereof.

11. The method of claim 8 further comprising adding a binder before, during, or after combining the bacterial cellulose with the gel.

12. The method of claim 11 wherein the binder is selected from guar gum, ammonium lignosulfonate, chitosan, lignin, arrowroot, cassava, tapioca, yucca, manioc, organic starch, potato starch, pectin, [poly (Acrylic acid-co-N-Methylol Acrylamide-co-Butyl Acrylate) Copolymer Grafted Carboxymethyl Cellulose], soy protein, polyacrylic acid, liquid plant hydrolysate, magnesium oxide, xanthan gum, agar, sargassum, seaweed extract, kelp, sulfite liquor, wheat flour, sucrose, and mixtures thereof.

13. The method of claim 8 further comprising adding an additive before, during, or after combining the bacterial cellulose with the gel.

14. The method of claim 13 wherein the additive is selected from polyhydroxyalkanoate (PHA), polylactide (PLA), polybutylene adipate terephthalate (PBAT), polybutyl succinate (PBS), cellophane, glycerol monostearate, shellac, wax, natural gum, castor oil, flax oil, linseed oil, menthol crystals, zein, dyes, colorants, glycerin, alcohols, polyols, and mixtures thereof.

15. The method of claim 8 wherein the compressing of the semi-solid mass and the dehydrating of the semi-solid mass are conducting simultaneously.

16. The method of claim 8 wherein the dehydrating the semi-solid mass is conducted at a temperature and for a period of time to reduce an amount of water in the semi-solid mass such that the synthetic wood includes water in an amount less than about 5%.

17. The method of claim 8, further comprising applying a resin to the synthetic wood.

18. A synthetic wood comprising bacterial nanocellulose and having a density and a stiffness.

19. The synthetic wood of claim 18, wherein the density ranges from about 0.4 g/cm³ to about 2.0 g/cm³.

20. The synthetic wood of claim 18, wherein the stiffness ranges from about 2 GPa to about 20 GPa.
